(19) United States
(12) Patent Application Publication
(10) Pub. No.: US 2021/0316329 A1
(43) Pub. Date: Oct. 14, 2021

(54) DOCTOR BLADE WITH POLYMERIC RETENTION MEANS, DOCTOR BLADE HOLDER COMPRISING SUCH A DOCTOR BLADE AND METHOD FOR PROVIDING RETENTION MEANS ON A DOCTOR BLADE

(71) Applicant: KADANT INC., Westford, MA (US)

(72) Inventors: Michael DRAPER, Lancashiregb (GB); Kevin CALLUS, Clitheroe (GB); Robert LUCAS, Lancashire (GB)

(21) Appl. No.: 17/271,725

(22) PCT Filed: Aug. 30, 2019
(86) PCT No.: PCT/US2019/049188

§ 371 Date: Feb. 26, 2021

Related U.S. Application Data
(60) Provisional application No. 62/725,459, filed on Aug. 31, 2018.
(60) Provisional application No. 62/730,302, filed on Sep. 12, 2018.

(51) Int. Cl. B05C 11/04; D21G 3/00

(52) U.S. Cl. CPC B05C 11/044; D21G 3/005; B05C 11/045

(57) ABSTRACT

A doctor blade is disclosed that includes a blade surface and at least one shaped feature that is formed of a polymeric material and is provided to assist in maintaining the doctor blade with a doctor blade holder.

### PRIORITY

The present application claims priority to U.S. Provisional Patent Application Ser. No. 62/725,459 filed Aug. 31, 2018 as well as to U.S. Provisional Patent Application Ser. No. 62/730,302 filed Sep. 12, 2018, the disclosures of which are hereby incorporated by reference in their entireties.

### BACKGROUND

The invention generally relates to doctor blades used in industrial process machines and relates in particular to retention features that are used to hold doctor blades in their holders in the papermaking, industrial processing, web converting, printing and other doctor blade using industries.

Doctor blades are predominantly used on papermaking and web converting machines to clean contaminants from roll surfaces or remove water or other liquids. Additionally, in some applications, doctor blades are used to remove and/or guide the product during machine start-ups and when product breaks/upsets occur. Doctor blades are held in a blade support device known as a doctor blade holder. The current industry standard doctor blade holder utilizes a lower finger or jaw-type blade retention member attached to a top plate and creating a cavity therebetween. One end of a doctor blade is held in the cavity with the top plate and lower jaw member cooperating to hold the blade against a roll. The blade is traditionally fitted with metallic rivets, washers and spring clips to keep it securely in place during operation.

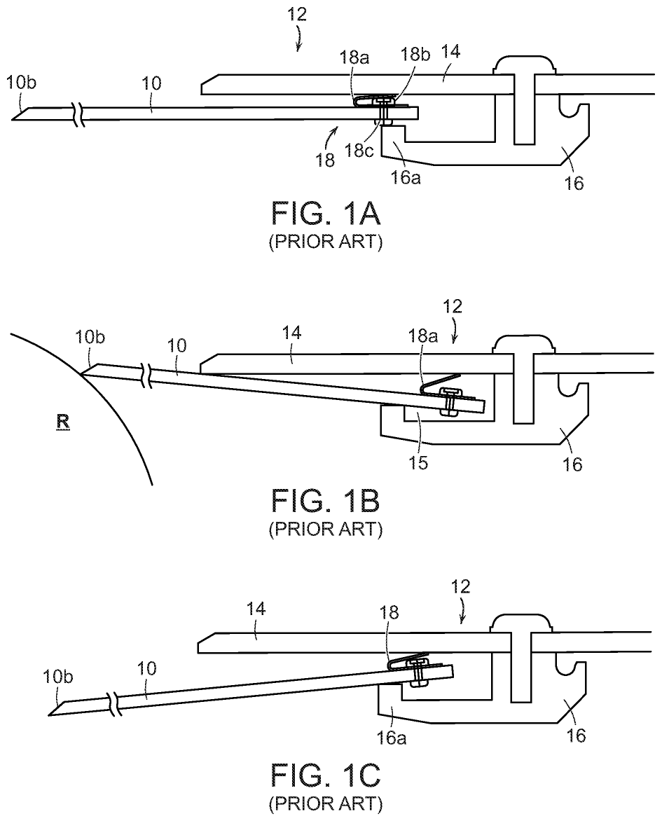

FIG. 1A for example, shows a doctor blade 10 being inserted into a doctor blade holder 12 between top plate 14 and lower jaw 16. At the back end 10a of the blade 10 is a retention device 18 that includes a spring clip 18a secured to the blade 10 with a rivet 18b and washer 18c. The spring clip 18a is compressed to fit into the opening between top plate 14 and a finger portion 16a of lower jaw 16.

FIG. 1B shows the blade 10 in an operational position with the back end 10a of the blade 10 held within a cavity 15 formed between the top plate 14 and lower jaw 16. The force of the spring clip 18a against the top plate 14 encourages the doctoring end 10b of the blade 10 to rotate to an upwards-angled position for proper orientation to engage roll R. In many applications, especially with rolls that have a soft synthetic cover, this upwards angled position of the blade is a requirement to prevent damage to the roll cover during doctor blade loading.

On the other hand, FIG. 1C illustrates an undesirable situation, one that could lead to roll cover damage, where the blade 10 is in a downward angled position due to a spring clip 18a that is absent or over-flattened or a top washer 18c that is too thin for the application. In this position, the doctoring end 10b of the blade 10 can dig into and damage the roll R, the blade 10, retention device 18, or blade holder 12. Additionally, the spring clip 18a may be compressed to the point where the blade 10 may not be secured into blade holder 12, and may fall out the holder 12 when the blade 10 is pulled away from the roll R.

This issue arises in practice when the spring clips become permanently flattened during the blade insertion process or after repeated engagement/disengagement of the blade. Once flattened, these spring clips can no longer maintain the blade in the proper upward angled position. Furthermore, flattened spring clips may result in the blade falling out of the doctor blade holder potentially causing injury to nearby personnel or damage to the process machinery. The sharp edge of the spring clip can also cut into the underside of the holder top plate during blade changes and use, permanently damaging the top plate of the blade holder.

The conventional rivet/washer/spring clip method of retaining blades requires many different rivet lengths, washer thicknesses combinations thereof to accommodate various blade thicknesses, which can typically range from approximately 0.25 mm to 4.0 mm. The typical fixing method for the spring clip involves punching or machining holes for each assembly into the doctor blade; inserting rivets into the respective holes; fitting a spring clip onto the stem of the rivets; adding a washer to each rivet stem and then peening over the remaining rivet stem to lock the clip on to the doctor blade. In some cases, spring clips are not required, and rivets alone are able to hold the blades in place. Either way, this method is very labor intensive to perform manually and very expensive to automate.

Furthermore, as seen in FIG. 2, the process of securing a spring clip 18 with rivets 18b/c places a lot of stress on blade 20, which may be made of several laminated layers. While making holes in the blade 20 by punching or machining, or when peening over the rivets using repeated blows or intense pressure, stress fractures may by introduced in and around holes 22. This process additionally may cause areas 24 of delamination between layers of the blade, again weakening the blade structure. Once the fractures or delamination are introduced, vibrations and repeated stress during operation propagate the fractures and delamination, which significantly weaken the blade and ultimately lead to blade failure.

The conventional metal rivet, washers and spring clips also have the tendency to loosen and fall out during operation. This situation, along with blade failure, can cause extensive damage to the process machinery when pieces or fragments get lodged in moving parts of the machinery.

Due to the above-mentioned deficiencies and problems associated with the conventional doctor blade retention using rivets, washers and spring clips, there remains a need for an improved, less costly, safer, and more reliable doctor blade retention means.

### SUMMARY

In accordance with an embodiment, the invention provides a doctor blade including a blade surface and at least one shaped feature that is formed of a polymeric material and is provided to assist in maintaining the doctor blade with a doctor blade holder.

In accordance with another embodiment, the invention provides a doctor blade holder system including a doctor blade holder, a top plate, and a doctor blade that includes a polymeric shaped feature thereon that is provided to assist in maintaining the doctor blade between the doctor blade holder and the top plate.

In accordance with a further embodiment, the invention provides a method of providing a doctor blade comprising the steps applying at least one shaped feature that is formed of a polymeric material onto a surface of the doctor blade, wherein the at least one shaped feature is provided to assist in maintaining the doctor blade with a doctor blade holder.

### DETAILED DESCRIPTION

The following description may be further understood with reference to the accompanying drawings in which:

FIGS. 1A-1C show illustrative diagrammatic side views of a prior art blade retention means in various states of engagement with a blade holder;

FIG. 2 shows an illustrative diagrammatic isometric view of potential damage caused by the prior art;

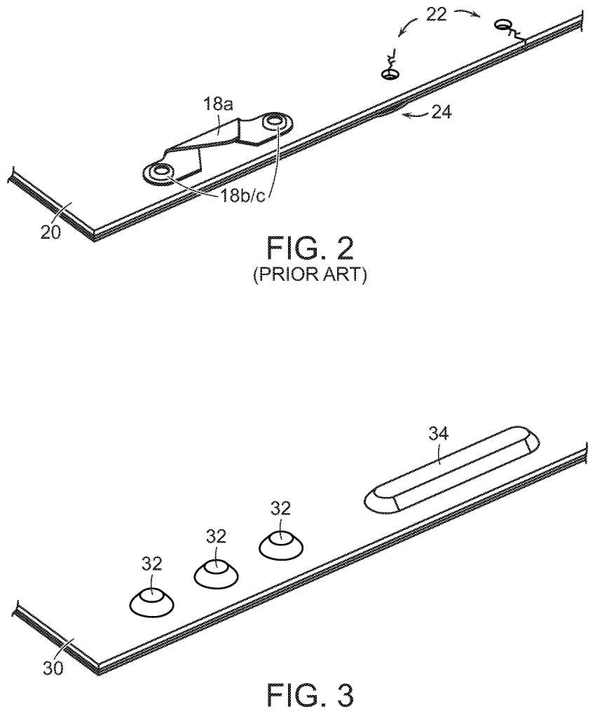

FIG. 3 shows an illustrative diagrammatic isometric view of example embodiments of the present invention;

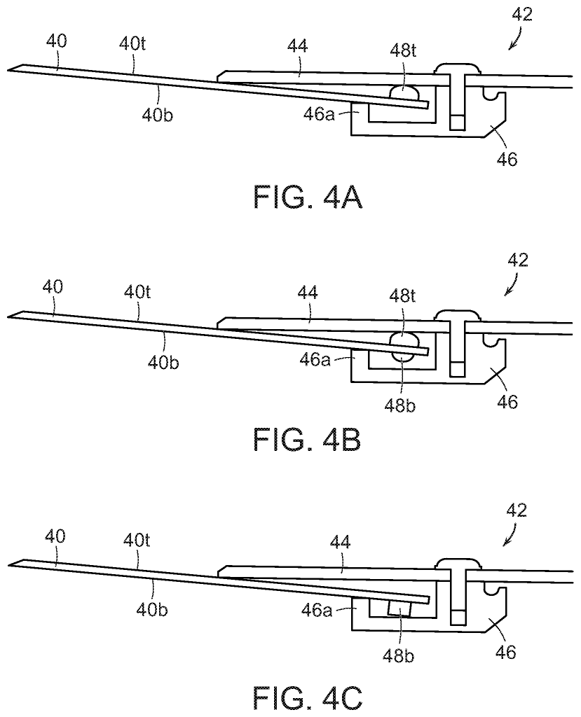

FIGS. 4A-4C show illustrative diagrammatic side views of various placement options for blade retention features of the present invention;

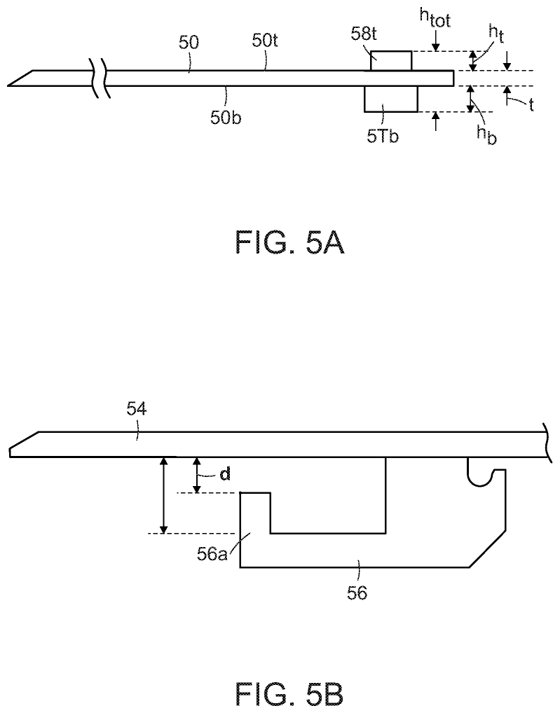

FIGS. 5A and 5B show illustrative diagrammatic side views of a blade d blade holder, respectively, of various embodiments of the invention;

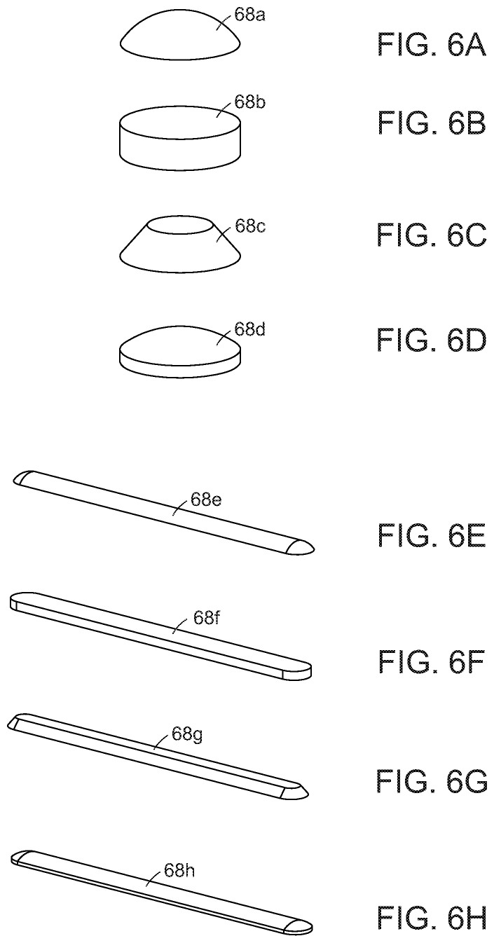

FIGS. 6A-6H show illustrative diagrammatic views of protuberance shapes of various embodiments of the invention;

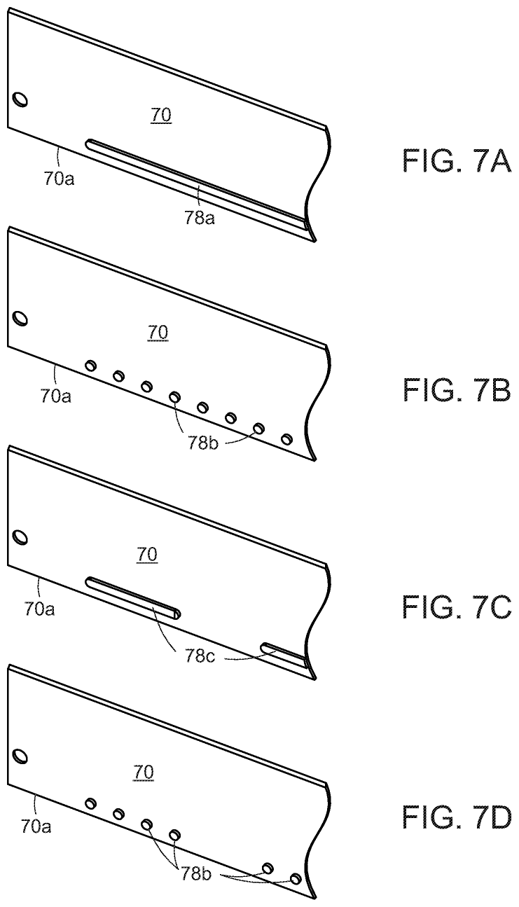

FIGS. 7A-7D show illustrative diagrammatic protuberance configurations of various embodiments of the invention;

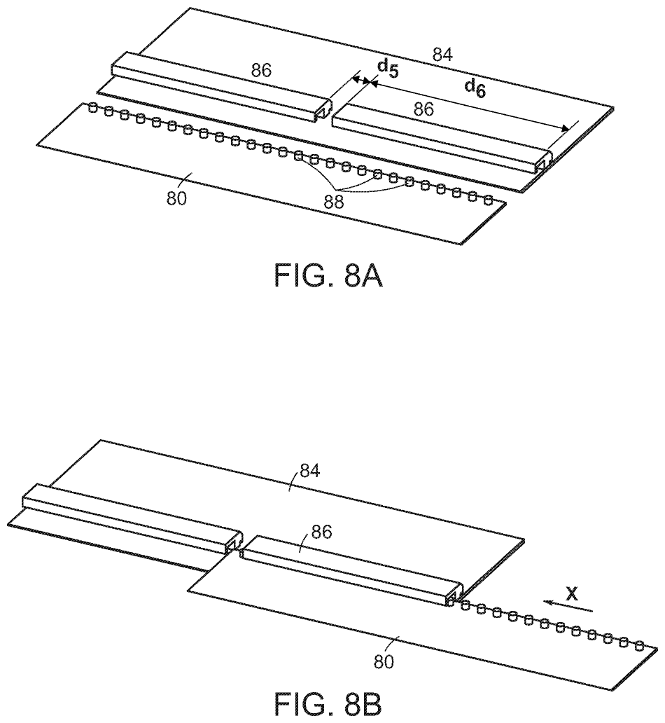

FIGS. 8A and 8B show illustrative diagrammatic views of a first installation procedure;

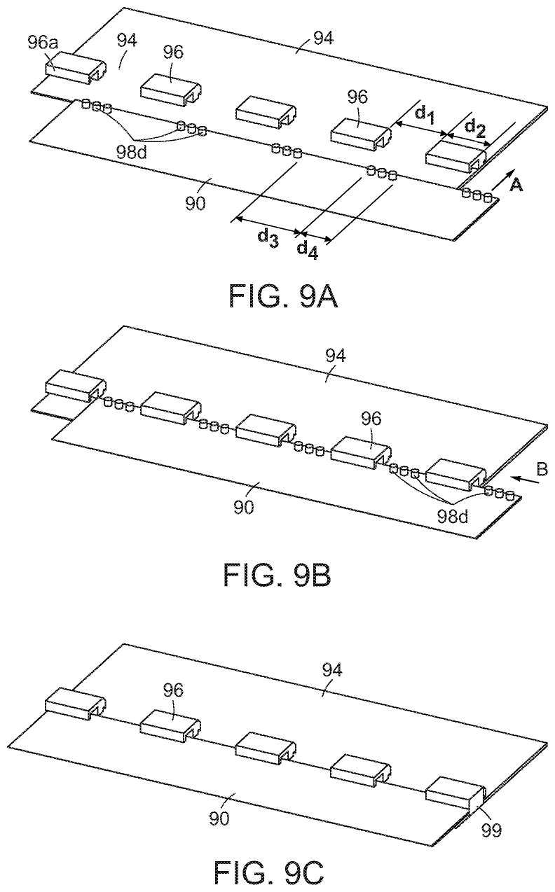

FIGS. 9A-9C show illustrative diagrammatic views of a second installation procedure;

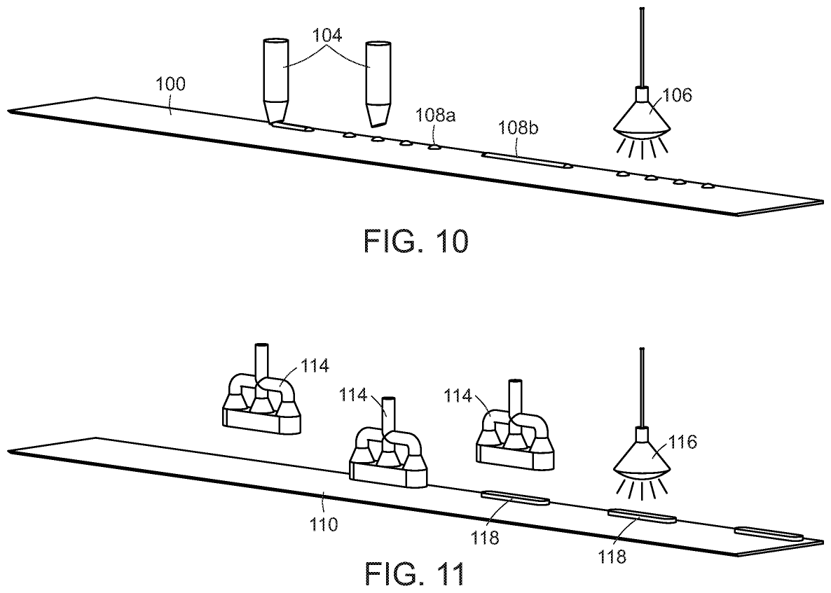

FIG. 10 shows an illustrative diagrammatic view of a first protuberance application procedure;

FIG. 11 shows illustrative diagrammatic views of a second protuberance application procedure; and

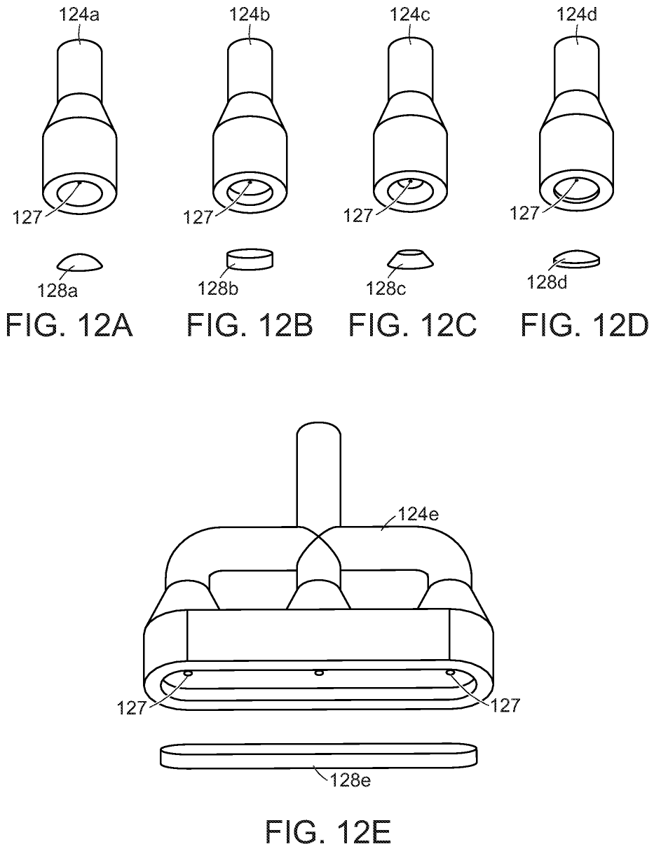

FIGS. 12A-12E show illustrative diagrammatic views of protuberance molds.

The drawings are shown for illustrative purposes only.

### DETAILED DESCRIPTION

This invention overcomes the problems currently associated with conventional types of doctor blade retention means. The embodiments of the present invention eliminate the need to punch, rivet, countersink and clip doctor blades and has the potential to transform blade finishing.

In accordance with various embodiments, the invention provides for dispensing a polymeric material onto a blade in a controlled manner to give a pre-determined size of droplet or line that quickly sets or cures, creating a stable protuberance on the blade surface. As seen in FIG. 3, the spring clips and rivets of the FIG. 2 have been replaces with surface-attached protuberances in the shape of buttons 32 and bar 34. These buttons 32 and bars 34 are applied in a non-destructive manner that allows for proper blade retention while increasing the safety and reliability of the blade retention features.

The blade retention features of various embodiments of the invention can be located in three main configurations. As seen in FIG. 4A, top surface protuberances 48t extend from the top surface 40t of blade 40. The top protuberances contact the top plate 44 of blade holder 42, while finger 46a of lower jaw 46 contacts the lower surface 40h of blade 40, preventing the blade 40 from falling out of the blade holder 46.

In FIG. 4B, blade 40 has both top protuberances 48t extending from the top surface 40t of blade 40, and bottom protuberances 48b extending from the bottom surface 40b of blade 40. The combined thickness of the blade 40 and the top and bottom protuberances 48a/b prevent the blade from falling out by having a total height that is greater than the distance between the top plate 44 and the finger 46a of the lower jaw 46.

FIG. 4C shows an embodiment where only a bottom protuberance 48b protrudes from blade 40. In this configuration, the total height of the blade 40 and bottom protuberance 48b must be greater than the distance between the top plate 44 and the finger 46a of the lower jaw 46 to prevent the blade from falling out the blade holder 42.

As shown in FIGS. 5A and 5B, regardless of which configuration the protuberances are provided, a main feature of the blade retention features 58 is that the total height hₜₒₜ of the blade 40 and the protuberances 48 is greater than the distance d between the top plate 54 and the finger 56a of the lower jaw 56. As seen in FIG. 5A, the total height hₜₒₜ is composed of the thickness t of the blade 50, the height hₜ of any top protuberance 58t, and the height h_{b} of any bottom protuberance 58b. This can be represented by the inequality d>hₜ+h_{b}+t, where hₜ is zero if there is no top protuberance, and h_{b} is zero if there is no bottom protuberance.

The protuberances can be shaped in a variety of ways. FIGS. 6A-6D present example drop or button shapes, and FIGS. 6E-6H present example bar shapes. Specifically, FIGS. 6A, 6B, 6C, and 6D show buttons being spherical/elliptical, cylindrical frustoconical, and cylindrical with a domed top, respectively. FIGS. 6E, 6F, 6G, and 6H show bars that are elongated versions of the buttons of FIGS. 6A, 6B, 6C, and 6D, respectively.

As shown in FIGS. 7A-7D, the protuberances can be arranged on the back edge 70a of blade 70 in various configurations. For example, in FIG. 7A, an elongated cylinder shape as in FIG. 6F extends continuously along the blade 70. In FIG. 7B, cylinder buttons as in FIG. 6B extend in continuous intervals along the blade 70. In FIG. 7C, lengths of elongated cylinders 78c extend in periodic intervals along blade 70. In FIG. 70D, groups of cylindrical buttons 78d extend in periodic intervals along blade 70.

The material used for the protuberances generally has less resiliency than the spring clips of the prior art, which makes installation of the blades from the front by compressing the protuberances between the top plate and lower jaw undesirable, as the tolerances would be fairly important to ensure the blade stayed in the blade holder. One installation option is shown in FIGS. 8A and 8B, where the blade 80 having a continuous line of protuberances 88c does not provide clearance to get into lower jaws 86, and must be slid in from the side as shown in FIG. 8B. Note that while the protuberances are shown as a continuous line of buttons, this could arise when the protuberances are presented as one or more bars extending along the blade.

Alternatively, as shown in FIGS. 9A-9C, if the spacing d₃ between discontinuous groups of protuberances 98d (shown as buttons, but which could be bars as well) is less than the width d₂ of discontinuous lower jaws 96, and the width d₄ of the groups of protuberances 98d is less than the spacing d₁ between the lower jaws 96, the blade 90 can be moved in direction A such that the protuberances move past fingers 96a of lower jaws 96. Once there, the blade 90 can be slid in direction B along the longitudinal direction of the blade such that the protuberances are aligned with the lower jaws 96. Once aligned, the blade can be prevented from moving laterally out of this position fingers 96a of lower jaws 96. Once there, the blade 90 can be slid in direction B along the longitudinal direction of the blade such that the protuberances are aligned with the lower jaws 96. Once aligned, the blade can be prevented from moving laterally out of this position by end caps 99 or by other devices to prevent lateral motion.

The protuberances can be applied to the blades in a variety of manners. As shown in FIG. 10, applicators 104 can be used to apply material down onto blade 100 in discrete volumes as buttons 108a or extended volumes as bars 108b. Once on the blade, a curing device 106 is used to harden the protuberance material or otherwise cause the material to harden and/or bond to the blade more permanently.

Another method of application, as shown in FIG. 11, uses molds 114 that can either dispense a known volume of material therethrough and shape material therein, where the material is released from the molds having sufficient stiffness to retain its shape until it is able to be cured by curing device 116. The molds may use heat to partially harden the material before curing, or may retain the material for sufficient time to partially harden the material before releasing it.

As seen in FIGS. 12A-12E, material molds can be made in various shapes to accommodate different protuberance shapes. For example, FIGS. 12A, 12B, 12C, and 12D show molds 124a, 124b, 124c, 124d and 124e, respectively, that create protuberances 128a, 128b, 128c, 128d and 128e, respectively. Each of the molds optionally has material orifices 127 that introduce material into the molds for shaping and initial hardening. Alternatively, the molds can be pressed against material laid down by applicators such as the applicators 104 in FIG. 10, with the material being shaped and hardened with the mold. Molds can be heated by conventional means to provide heat-hardening.

Various materials can be chosen to provide desirable properties. For example, a UV curable polymeric material can be cured quickly under a UV bulb as a curing device. The method involves the UV curable polymer being deposited or dispensed onto a blade in a predetermined size or shape. This is then repeated along the length of the individual blade, series of joined blades or a coil of blade material, with the polymeric material being cured in seconds under a UV emitting lamp. Alternatively, a molten thermoplastic resin could be used that hardens on cooling. A further option would be to use an LED light curable polymeric material, whilst fusing a thermoplastic preform, in the shape of a retention aid, onto a blade provides a further way of achieving the same result.

A typical resin to use would be a modified acrylic resin, particularly a one-component high speed curing resin, a high performance thermoplastic resin or a snap-cure resin. The resin must have the ability to form a very strong bond to the doctor blade surface, have operational temperature capability, for example to 150° C., have sufficient viscosity to hold its shape prior to curing, to cure or set quickly and have both toughness and durability when exposed to water, caustic or acidic solutions, and otherwise harsh conditions.

The cured polymeric protuberances are typically 0.125 to 0.500 inches wide and 0.020 to 0.250 inches in height. The cured polymeric elongated shapes are typically 0.125 to 0.500 inches wide, 0.020 to 0.250 inches in height with a length that is 1 to 50 times its width, or continuous along the full length of the blade.

Joined blades include both lengths of blade material mechanically joined together and a single length of blade material with perforations or scored joints that can be easily snapped or broken to produce individual blade lengths after processing.

Important benefits of the invention are that it would eliminate expensive labor intensive punching and standard riveting from the production process and would result in a simpler, faster and significantly more efficient operation that could be applied to both paper and industrial doctor blade applications. It would also provide a clean dry method of applying doctor blade retention aids that would be free from dust. In addition, the invention eliminates the potential of any detrimental crack propagation or delamination originating from punched holes. A further benefit is that polymeric rivets would be less damaging to roll covers or machine felts and fabrics when compared to traditional metal rivets in the event of a rivet coming off or out of the blade.

Those skilled in the art will appreciate that numerous variations and modifications may be made to the above disclosed embodiments without departing from the spirit and scope of the present invention.

What is claimed is:

1. A doctor blade comprising a blade surface and at least e shaped feature that is formed of a polymeric material and is provided to assist in maintaining the doctor blade with a doctor blade holder.

2. The doctor blade as claimed in claim 1, wherein the shaped feature includes a resin material.

3. The doctor blade as claimed in claim 1, wherein the shaped feature includes an acrylic resin.

4. The doctor blade as claimed in claim 1, wherein the shaped feature is curable.

5. The doctor blade as claimed in claim 4, wherein the shaped feature is light curable.

6. The doctor blade as claimed in claim 4, wherein the shaped feature is heat curable.

7. The doctor blade as claimed in claim 1, wherein the doctor blade includes a plurality of shaped features that are provided to rest against a surface of a doctor blade holder.

8. The doctor blade as claimed in claim 1, wherein the shaped feature is elongated along a length of the doctor blade.

9. A doctor blade holder system comprising a doctor blade holder, a top plate, and a doctor blade that includes a polymeric shaped feature thereon that is provided to assist in maintaining the doctor blade between the doctor blade holder and the top plate.

10. The doctor blade holder system as claimed in claim 9, wherein the shaped feature includes a resin material.

11. The doctor blade holder system as claimed in claim 9, wherein the shaped feature includes an acrylic resin.

12. The doctor blade holder system as claimed in claim 9, wherein the shaped feature is curable.

13. The doctor blade holder system as claimed in claim 12, wherein the shaped feature is light curable.

14. The doctor blade holder system as claimed in claim 12, wherein the shaped feature is heat curable.

15. The doctor blade holder system as claimed in claim 9, wherein the doctor blade includes a plurality of shaped features that are provided to rest against a top plate in the doctor blade holder.

16. The doctor blade holder system as claimed in claim 9, wherein the shaped feature is elongated along a length of the doctor blade.

17. The doctor blade holder system as claimed in claim 9, wherein the shaped feature is on a portion of the doctor blade that is within a finger or jaw of the doctor blade holder system.

18. The doctor blade holder system as claimed in claim 9, wherein the shaped feature is positioned on a top side of the doctor blade.

19. The doctor blade holder system as claimed in claim 9, wherein the shaped feature is positioned on a bottom side of the doctor blade.

20. The doctor blade holder system as claimed in claim 9, wherein the shaped feature includes shaped features on both a top side of the doctor blade and a bottom side of the doctor blade.

21. A method of providing a doctor blade, said method comprising the steps applying at least one shaped feature that is formed of a polymeric material onto a surface of the doctor blade, wherein the at least one shaped feature is provided to assist in maintaining the doctor blade with a doctor blade holder.

22. The method as claimed in claim 21, wherein the at least one shaped feature is cured following application to the doctor blade.
